(19) United States
(12) Patent Application Publication
(10) Pub. No.: US 2014/0076860 A1
(43) Pub. Date: Mar. 20, 2014

(54) Sensing Apparatus for Resistance Welding and Related Method

(71) Applicants: Bob Morrow, Georgetown, KY (US); George Kurz, Cynthiana, KY (US)

(72) Inventors: Bob Morrow, Georgetown, KY (US); George Kurz, Cynthiana, KY (US)

(21) Appl. No.: 14/026,492

(22) Filed: Sep. 13, 2013

Related U.S. Application Data
(60) Provisional application No. 61/700,671, filed on Sep. 13, 2012.

(51) Int. Cl. B23K 11/25

(52) U.S. Cl. CPC B23K 11/251
USPC 219/110

(57) ABSTRACT

A sensing system measures the voltages between the electrodes of a resistance welding apparatus. The resistance welding apparatus has a pair of welding electrodes configured to come into electrical contact to effect a weld, a weld controller and a controller rectifier. The sensing system includes a voltmeter for measuring a voltage between the pair of electrodes and a sensor for sending a signal to initiate welding to the weld controller based on the measured voltage between the pair of welding electrodes. Related methods are also described.

This application claims the benefit of U.S. Provisional Patent Application Ser. No. 61/700,671, filed on Sep. 13, 2012, the disclosure of which is incorporated herein by reference.

### TECHNICAL FIELD

The present invention relates generally to resistance welding and, more particularly, to a sensing apparatus for a resistance welding apparatus for more efficiently and safely performing manual welding operations and a related method for detecting the voltage between the welding electrodes of the spot welder to reduce the risk of injury to the operator.

### BACKGROUND

Resistance welding is one of the oldest electric welding processes used in various industries today. It is a welding process requiring the application and combination of heat, pressure and time to form a weld. As the name resistance welding implies, it is the resistance of the material to be welded to electrical current flow that causes a localized heating in the joint and the weld is made.

One of the most common forms of resistance welding is spot welding wherein pressure is provided by clamping a workpiece, such as two overlapping sheets of metal between two welding electrodes, such as copper or copper alloy electrodes. The pressure of the tips of the electrode on the workpiece holds the workpiece in intimate contact as a current is passed between the electrodes, which generates a sufficient amount of heat at the interface by resistance to the flow of the current that melting occurs. As a result, a weld nugget is formed and a fusion weld is made between the sheets. Unlike other forms of welding, the actual weld nugget is formed internally in relation to the surface of the base metal. Moreover, the energy is delivered to the spot in a short time period, so that welding occurs without excessive heating of the remainder of the sheet. The welding process may be effected by a number of variables, including the type and size of the material to be welded, the amount of current flowing and the size of the electrode tip surfaces.

Spot welding may employ electrical power in the form of direct current, alternating current, medium frequency half-wave direct current, or high-frequency half wave direct current. The primary welding parameters in this type of process are current, pressure and time. Spot welding is extensively used in the automobile manufacturing industry and in the aerospace industry for welding different types of metals, such as steel and aluminum alloys. In spot welding operations, a welding head may be mounted on a pedestal, bench, dedicated machine or other manually operated pedestal machine.

There are a number of advantages for spot welding, such as efficient energy use, limited workpiece deformation, high production rates, easy automation, and no required filler materials. However, there are certain disadvantages associated with spot welding, especially manually operated resistance spot welding machines. Namely, these types of machines expose the operator to potentially serious injuries due to the pinch point area between the welding electrodes. For example, a start button is typically pressed by an operator, which drives an actuator or cylinder down until the top electrode presses against the bottom electrode so as to close on the workpiece. The start button is also connected to the start signal on the weld controller. The weld controller has a set amount of time programmed into it for delaying the welding current from turning on to effectuate the weld. The purpose of the delay is to provide a sufficient amount of time for the cylinder to extend down and press against the bottom electrode. Once the delay time has elapsed, the weld controller turns on a silicon-controlled rectifier (SCR) which passes high current through the welding transformer in order to make the weld.

Generally, the operator must load the workpiece between the welding electrodes and hold the workpiece to be welded together between the top and bottom electrodes at the same time the start button is pressed. If any part of the operator's hand or fingers is present between the welding electrodes after the programmed delay has passed, the operator's hand or fingers may be crushed or otherwise injured by the high force of the moving electrode during the welding process.

Accordingly, a need is identified for a sensing apparatus for a resistance welding machine that allows for the utilization of the advantages of the spot welding process while reducing the risk of serious injury to the operator by detecting the voltage between the two electrodes of the welding machine before initiating the welding process.

### SUMMARY

A sensing system for intended use with a resistance welding apparatus is disclosed. The resistance welding apparatus has a pair of welding electrodes configured to come into electrical contact to effect a weld, a weld controller and a controller rectifier. The system includes a voltmeter for measuring a voltage between the pair of electrodes and a sensor for sending a signal to the weld controller based on the measured voltage between the pair of welding electrodes.

The system may further include a cylinder for driving one of the welding electrodes, a low pressure valve and a high pressure valve connected to the cylinder and a processor. In one embodiment, the signal is sent to the weld controller when the measured voltage is less than 1 volt and no signal is sent to the weld controller when the measured voltage is greater than 1 volt. The measured voltage is a bleedthrough voltage from the controller rectifier.

Another related aspect of the disclosure is an improvement to a resistance welding apparatus having a weld controller, a controller rectifier, a first electrode, a second electrodes, a cylinder configured to move the first electrode into contact with the second electrode, and a high and low pressure valve for shifting the cylinder in a vertical direction. Specifically, the improvement includes a sensor in electrical contact with the weld controller and the controlled rectifier for measuring a voltage between the first and second electrodes and sending a signal to the weld controller based on the measured voltage between the pair of welding electrodes.

A further aspect of this disclosure is a method of resistance welding. The method includes driving a first electrode towards a second electrode in a low pressure mode and measuring a voltage between the first and second electrodes. The method further includes sending a signal to a weld controller if the measured voltage meets a predetermined value and switching into high pressure mode to effectuate a weld. In one embodiment, the method further includes the step of repeatedly measuring a voltage between the first and second electrodes after the switching step and sending a second signal to the weld controller if the repeatedly measured value is different than the predetermined value.

### BRIEF DESCRIPTION OF THE DRAWINGS

FIG. 1 is a perspective view in accordance with one embodiment of a representative upright pedestal spot welding machine;

FIG. 2 is a block diagram of the control wiring in accordance with one embodiment of a sensing apparatus system for use with a welding machine;

FIG. 3 is a block diagram of the pneumatic layout in accordance with one embodiment of the sensing apparatus system for use with the welding machine; and

FIG. 4 is a flow chart showing the control logic in accordance with one embodiment of the present invention the sensing apparatus system for use with the welding machine.

### DETAILED DESCRIPTION

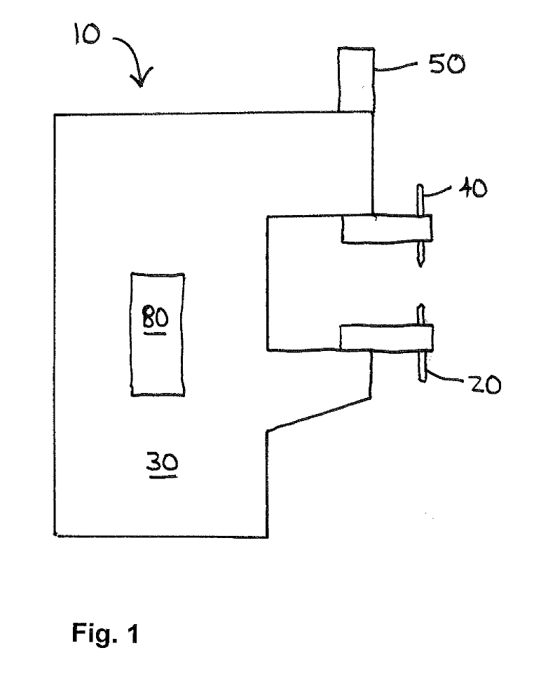

As shown in FIG. 1, a representative upright pedestal spot welder 10 designed for a variety of applications is illustrated. Generally, the welding machine 10 has a bottom or fixed welding electrode 20 positioned on the frame 30 of the machine and a top or moving welding electrode 40 mounted to a welding cylinder 50 on the frame of the machine. Generally, the fixed electrode 20 is positioned below the moving electrode 40. The cylinder 50 having the moving electrode 40 is shifted up and down vertically by a pair of solenoid operated air pressure valves (a low pressure valve 60 and a high pressure valve 70). A welding transformer 80 is connected across the top and bottom electrodes 20, 40.

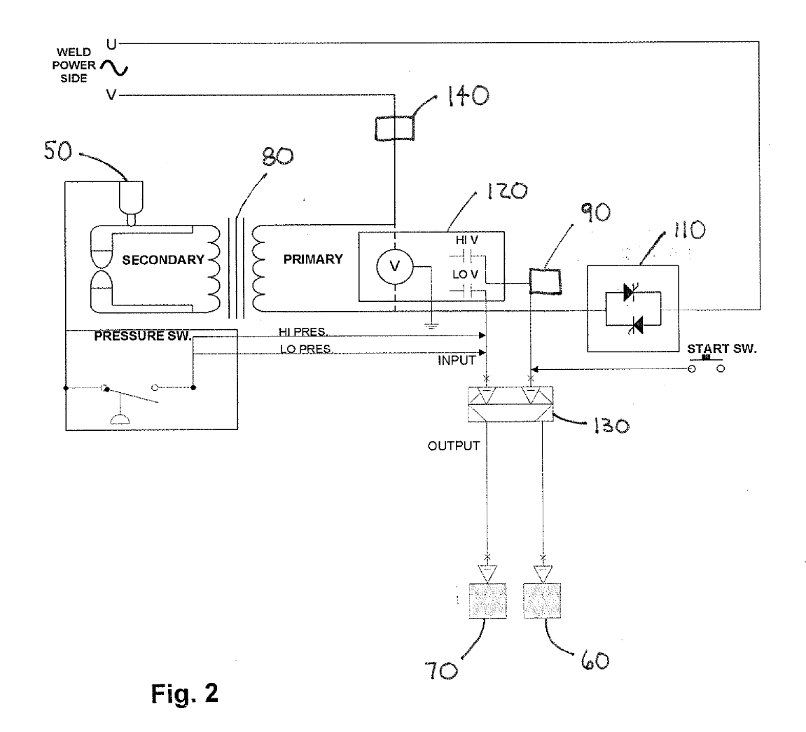

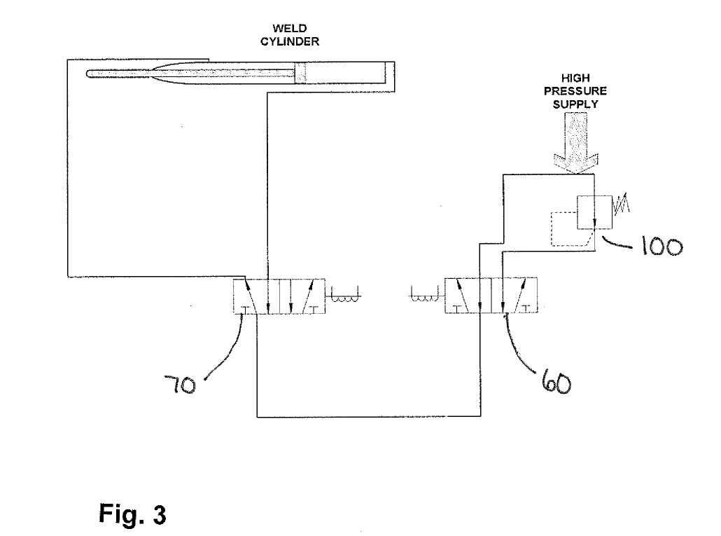

Turning to FIGS. 2 and 3, a sensing apparatus such as an analog voltage sensor or panel meter 90 is used with the welding machine 10 to confirm contact between the welding electrodes 20, 40 by utilizing an electrical circuit measuring voltage that is present on the primary voltage of the spot welding transformer. Initially, the moving welding electrode 40 is in a fully retracted position above the fixed welding electrode 20. Compressed air is supplied through a pressure regulator 100 and the low pressure valve is opened, which drives the cylinder 50 to move the moving welding electrode 40 vertically towards the fixed welding electrode 20 in low pressure mode, which will not cause any significant injury to an operator.

Before the welding electrodes make contact and before the SCR 140 turns on, there is a small but measurable voltage present from the SCR (typically less than 30 volts and usually around 18 volts). When the top and bottom electrodes make contact, the voltage dissipates (typically less than I volt). Thus, the sensing system looks for a significant drop in the voltage (confirming that the electrodes are touching and nothing, such as the operator's hand or fingers is in the way of the two electrodes) in order to begin the welding process.

Only when the start button is pressed by the operator and the voltage dissipates, can the start signal be sent to the weld controller 110, which aims to prevent operators from crushing their fingers by using a voltage detector or voltmeter 120 to control the two valves 60, 70. In more detail, the sensor 90 receives a voltage reading from the voltmeter 120, which is processed by a processor or programmable logic controller (PLC) 130 utilizing logic. Once the processor 130 completes processing the reading, if the received reading is less than I volt and preferably substantially 0 volts, the weld controller 110 initiates the welding operation. Specifically, compressed air is supplied through the pressure regulator 100 through the high pressure valve 70, which is now opened. Again, if the received reading indicates a certain amount of voltage (at least greater than 1 volt), the weld controller 110 never sends a signal to initiate the welding operation as the high pressure valve 70 remains closed.

Importantly, no value added work may be accomplished until the sensing system detects contact between the welding electrodes. In order for the start signal to be sent to the weld controller 110, the top and bottom electrodes must make contact and the contact must be verified by the sensor 90. The voltmeter 120 sends its reading to the sensor 90, which outputs to the processor 130 when high or low voltage conditions have been met. The processor 130 sends a signal to the weld controller 110 via the sensor 90 to switch to high pressure based on the voltmeter inputs reaching a specified reading.

In more detail, contact between the top and bottom electrodes is determined by using the SCR bleedthrough or leakage voltage instead of utilizing a comparator circuit that induces a low control voltage into the secondary wiring of the weld transformer. Advantageously, this eliminates the need for a comparator circuit, which also eliminates the need for a number of components, such as circuitry components like chips, resistors, diodes, transistors and the like that are not part of the welding circuit. These additional components not only add expense to the overall operation of the welding system, but these additional components can fail, which is costly and inefficient for obvious reasons.

Instead of relying upon a comparator circuit to induce a voltage into the welding transformer, the system relies on the resting bleedthrough voltage of the welding SCR, which is used as a control voltage that naturally exists. The bleedthrough voltage is the result of a natural phenomenon, which occurs in the welding SCR's at the positive-negative (P-N) region. Thus, any current that flows is due to the very weak process of carrier generation inside the depletion region due to generation-recombination defects in this region. The very small current is the source of the leakage current under reverse bias. When there is current flow, there is also voltage, which can be used to detect contact between the electrodes. By providing a path through the electrodes in the forward-bias direction, the bleedthrough voltages dissipates and the normal welding cycle may proceed in a customary manner.

In use, this system allows the cylinder to be brought down in low pressure mode and only switches to high pressure mode when contact between the welding electrodes has been confirmed by the measured voltage reading, i.e., a voltage reading of less than 1 volt. In other words, the cylinder initially comes down in low pressure mode and if the operator's hand is in the way, the cylinder never receives a signal from the weld controller to switch to high pressure mode to avoid injury to the operator as a voltage of greater than 1 volt will not be detected. However, while the cylinder is coming down in low pressure mode and the operator's hand is not in the way, the voltage dissipates when the welding electrodes come into contact and the cylinder switches to high pressure mode and the weld start signal is initiated by the weld controller. Thus, any significant injury to the operator caused by the high pressure should be avoided.

As discussed above, weld controllers often have a set amount of time programmed into it for delaying the welding current from turning on to effectuate the weld. This system removes the delay time from the weld controller such that the weld may begin as soon as the start signal is received, which improves the efficiency of the welding operation by reducing operation time, while not increasing safety concerns as safety concerns are addressed in other ways mentioned above. Finally, the sensor repeatedly and continuously monitors the voltage between the welding electrodes to confirm that the electrodes are not making contact after the weld is complete to avoid any damage to the automated equipment.

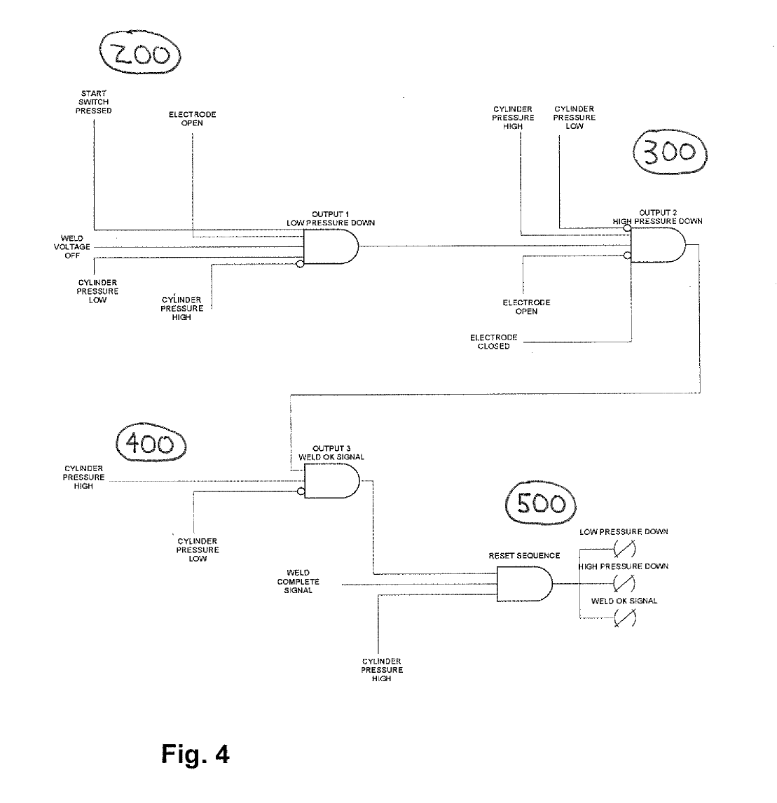

Turning to FIG. 4, a flow chart describing the operation of the weld process is illustrated. In the first step 200, the start switch is pressed. Since the welding electrodes are opened, i.e., they are not touching, a voltage is being read by the voltmeter and sensed by the sensing apparatus and, thus, the weld voltage is off. The cylinder pressure is in low pressure mode as indicated by the high pressure valve being closed. In the next step 300, the welding electrodes are no longer opened, but are closed. Thus, the voltage being read by the voltmeter and sensed by the sensor is substantially 0 volts. As a result, the cylinder pressure is switched to high pressure mode and the weld voltage is turned on. In the following step 400, the cylinder pressure is still in high pressure mode and the status of the welding is detected by the sensing apparatus via the voltmeter. If the weld is complete, a voltage will be read and communicated to the sensor because the welding electrodes will no longer be in direct electrical contact. This will signal a completed weld and lead to the final step 500, the reset sequence for the welding machine. On the other hand, if the weld is not complete, the welding electrodes will be still be in direct electrical contact and the voltage reading will be substantially 0 volts indicating that the weld is not complete and welding should continue under high pressure mode.

The foregoing descriptions of various embodiments are provided for purposes of illustration, and are not intended to be exhaustive or limiting. Modifications or variations are also possible in light of the above teachings. The embodiments described above were chosen to provide the best application to thereby enable one of ordinary skill in the art to utilize the disclosed inventions in various embodiments and with various modifications as are suited to the particular use contemplated. All such modifications and variations (including the combination of any or all of the embodiments disclosed into a single apparatus) are within the scope of the invention.

1. A sensing system for intended use with a resistance welding apparatus having a pair of welding electrodes configured to come into electrical contact to effect a weld, a weld controller and a controller rectifier, comprising:
a voltmeter for measuring a voltage between the pair of electrodes; and
a sensor for sending a signal to initiate welding to the weld controller based on the measured voltage between the pair of welding electrodes.

2. The system according to claim 1, wherein the signal is sent to the weld controller when the measured voltage is less than 1 volt.

3. The system according to claim 1, wherein no signal is sent to the weld controller when the measured voltage is greater than 1 volt.

4. The system according to claim 1, wherein the measured voltage is a bleedthrough voltage from the controller rectifier.

5. The system according to claim 1, wherein the sensor is an analog voltage sensor.

6. The system according to claim 1, wherein the sensor is a panel meter.

7. The system according to claim 1, further comprising a cylinder for driving one of the welding electrodes.

8. The system according to claim 7, further comprising a low pressure valve and a high pressure valve connected to the cylinder.

9. The system according to claim 8, wherein high pressure valve is closed until the measured voltage is less than 1 volt.

10. The system according to claim 1, wherein the system is operable in one of a low pressure mode or a high pressure mode depending on the measured voltage.

11. The system according to claim 1, further comprising a processor.

12. In a resistance welding apparatus having a weld controller, a controller rectifier, a first electrode, a second electrode, a cylinder configured to move the first electrode into contact with the second electrode, and a high and low pressure valve for shifting the cylinder in a vertical direction, the improvement comprising: a sensor in electrical contact with the weld controller and the controlled rectifier for measuring a voltage between the first and second electrodes and sending a signal to the weld controller based on the measured voltage between the pair of electrodes.

13. The improvement for a resistance welding apparatus of claim 12, wherein the measured voltage is a bleedthrough voltage from the controller rectifier.

14. The improvement for a resistance welding apparatus of claim 12, wherein the sensor is configured to only send the signal to the weld controller when the measured voltage is less than 1 volt.

15. The improvement for a resistance welding apparatus of claim 12, wherein the low pressure valve is configured to remain open until the signal is sent to the weld controller.

16. A method of resistance welding, comprising:
driving a first electrode towards a second electrode in a low pressure mode;
measuring a voltage between the first and second electrodes;
sending a signal to a weld controller if the measured voltage meets a predetermined value;
switching into high pressure mode to effectuate a weld.

17. The method according to claim 16, wherein the switching step occurs immediately after the sending step.

18. The method according to claim 16, wherein the sending step only occurs if the measured voltage is less than 1 volt.

19. The method according to claim 16, further comprising repeatedly measuring a voltage between the first and second electrodes after the switching step.

20. The method according to claim 19, further comprising sending a second signal to the weld controller if the repeatedly measured value is different than the predetermined value.
